(19) United States
(12) Patent Application Publication
(10) Pub. No.: US 2004/0178586 A1
(43) Pub. Date: Sep. 16, 2004

(54) Sealing element

(75) Inventor: Agur Junge, Berlin (DE)

Correspondence Address: HAHN LOESER & PARKS, LLP, TWIN OAKS ESTATE, 1225 W. MARKET STREET, AKRON, OH, 44313, US

(73) Assignee: Biotronik GmbH & Co. KG

(21) Appl. No.: 10/782,543

(22) Filed: Feb. 18, 2004

(30) Foreign Application Priority Data
Feb. 20, 2003 (DE) 103 08 163.1
May 13, 2003 (DE) 103 22 244.8

(51) Int. Cl. H02G 15/013

(52) U.S. Cl. 277/602

(57) ABSTRACT

The invention concerns a sealing element (10) of elastic material comprising a tubular main body (12), the peripheral wall (22) of which encloses a hollow space with a connecting passage (24) for fluids, wherein the peripheral wall (22) in the region of the connecting passage (24) is so designed in respect of elasticity of the material, wall thickness and inside diameter, that twisting of the main body (12) causes a constriction of the hollow space in the region of the connecting passage (24).

The invention concerns a sealing element of elastic material comprising a tubular main body and two longitudinal ends, the peripheral wall thereof enclosing a hollow space with a connecting passage for fluids.

### BACKGROUND OF THE ART

Such sealing elements are used for example in the form of gland seals as hemostatic valves in insertion catheters. Insertion catheters are used for example in connection with the implantation of electrode lines for cardiac pacemakers or defibrillators. An insertion catheter usually includes an elongate flexible tube, through which for example the electrode line is inserted into a blood vessel. For insertion of the electrode line the insertion catheter must be open for the electrode line both at the distal end and at the proximal end. At the same time the escape of blood through the insertion catheter which is necessarily open at both ends is to be avoided as far as possible. For that purpose a hemostatic valve is usually provided in the region of the insertion opening serving for insertion of the electrode line, at the proximal end of the insertion catheter, the valve comprising elastic material and sufficiently closely embracing the electrode line as to prevent the escape of blood.

Such hemostatic valves are usually in the form of gland seals or in the form of slit sealing disks.

U.S. Pat. No. 5,464,189 to Li (issued 7 Nov. 1995) also discloses a catheter valve with a variable opening which can be constricted by torsion so as to provide a connecting passage of variable diameter.

The handling of hemostatic valves of that kind generally leaves something to be desired. Particularly in Li '189, there is the disadvantage that the sealing element set forth therein extends over the entire length of the portion which is not gripped (free length) of the sealing element. In order in the case of such a sealing element to achieve a desired connecting passage which closes in a diaphragm-like manner, the free length of the sealing element must be selected to be very short in comparison with the diameter, as is shown in FIG. 30 or 34 of Li '189. Otherwise, the constriction is of a shape which is inappropriate for the insertion of for example electrodes through the connecting passage, as is illustrated in FIGS. 4, 7, 10 or 13 of Li '189.

With that background in mind, the object of the present invention is to provide a hemostatic valve which as far as possible avoids disadvantages of known hemostatic valves in terms of handling thereof or the universal usability thereof.

### SUMMARY OF THE INVENTION

In accordance with the invention, that object is attained by a sealing element of the kind set forth in the opening part of this specification, the peripheral wall of which in the region of the connecting passage is so designed in respect of elasticity of the material, wall thickness and inside diameter, that twisting of the two longitudinal ends relative to each other causes regular folding of the peripheral wall in the region of the connecting passage and concomitantly therewith a reduction in the diameter of the connecting passage, which is dependent on a twist angle, in such a way that the constriction is at a predetermined position in relation to the longitudinal direction of the sealing element.

The invention is based on the realisation that, with suitable dimensioning of a tubular main body of elastic material, which is adapted to the material properties, the main body experiences constriction if the main body is twisted with respect to the longitudinal axis of its connecting passage. In the generalised sense the invention thus relates to a sealing element of elastic material having a tubular main body, the connecting passage of which is to be constricted by twisting of the main body with respect to the longitudinal axis of the connecting passage.

That principle of constricting a tubular main body of elastic material by twisting makes it possible to adapt the diameter of the connecting passage to the respective situation of use, by the choice of the twist angle. It has been found that astonishingly reproducibly very good sealing effects can be achieved with such a sealing element.

A sealing body with a wall thickness which is slight in relation to the diameter of the connecting passage, comprising a particularly flexurally soft material such as for example silicone rubber, exhibits the properties which are desired here.

In a preferred variant the wall thickness of the peripheral wall is smaller in the region of the connecting passage than in regions of the sealing element, which are further remote from the connecting passage. It is particularly preferred if the wall thickness becomes greater with increasing distance from the connecting passage or is only reduced in the region of the connecting passage. In the region of the connecting passage, it is advantageous to have a wall thickness which is as small as possible so that adequate sealing integrity and strength of the sealing element is still ensured. In that respect it is advantageous if the reduction in the wall thickness is afforded by a reduction in the outside diameter of the sealing element so that the hollow space in the interior of the sealing element, in its relaxed, completely open condition, is in the shape of a cylinder which is open at its ends.

Preferably the sealing element has a respective radially outwardly extending flange at each of its two longitudinal ends. With those flanges the longitudinal ends of the sealing element can be easily connected to control elements for twisting of the sealing element.

In addition in a specific embodiment the sealing element has at least at one longitudinal end a diaphragm which at least partially closes the sealing element. That diaphragm preferably has a central opening, the diameter of which is smaller than the diameter of the connecting passage in the fully open condition. The diaphragm acts as a second but non-adjustable hemostatic valve for example upon the insertion of an electrode line.

Suitable materials for such a sealing element are basically rubbers, in particular silicone rubber, of a hardness of greater than 30 Shore hardness and preferably between 50 and 70 Shore hardness. In that respect the sealing element is preferably of a one-piece configuration and comprises a homogeneous material.

A further aspect of the invention concerns an insertion catheter having a sealing element which acts for example as a hemostatic valve. Known catheters leave something to be desired in terms of the adjustability and handling of the sealing elements used. Accordingly a further object of the present invention is also to provide an insertion catheter with an improved sealing element.

According to the invention, that object is attained by an insertion catheter having a sealing element of the kind claimed herein.

The sealing element is preferably arranged in the region of an insertion opening of the insertion catheter. Such an insertion opening serves for the insertion for example of electrode lines, guide wires or also catheters for positioning intravascular vessel prostheses.

In that respect the sealing element is preferably arranged and designed for selectively closing or opening the insertion opening. For that purpose the insertion catheter preferably has two control elements which are rotatable relative to each other and which are each operatively connected to a respective longitudinal end of the sealing element for adjusting the diameter of the connecting passage of the sealing element. Those control elements are preferably arranged in the region of the insertion opening of the insertion catheter and can thus be readily reached by a physician. At the same time immediate proximity with the sealing element to be adjusted is possible.

The control elements are preferably designed in such a way that they retain various, mutually relatively rotated positions after adjustment. In that way a twist angle once set, and the diameter which is predetermined in that way for the connecting passage are retained after setting. For that purpose a preferred variant can provide that the control elements are so designed that they latch in various, mutually relatively rotated positions.

### BRIEF DESCRIPTION OF THE DRAWINGS

The invention will now be described in greater detail by means of an embodiment with reference to the accompanying Figures in which:

FIG. 1 is a side view of a sealing element according to the invention,

FIG. 2 shows the sealing element of FIG. 1 in the twisted condition,

FIG. 2a shows a first variant of the folding of the sealing element,

FIG. 2b shows a second variant of the folding of the sealing element,

FIG. 3 shows an alternative variant of the sealing element in a sectional view,

FIG. 4a is a side view of a hemostatic valve according to the invention,

FIG. 4b is a view in longitudinal section through the hemostatic valve of FIG. 4a,

FIG. 5 shows elements of a distal end of an insertion catheter having a hemostatic valve as shown in FIGS. 4a and 4b as a sectional view, and

FIG. 6 shows a further variant as an alternative to FIG. 3 of the sealing element as a sectional view.

### DETAILED DESCRIPTION OF A PREFERRED EMBODIMENT

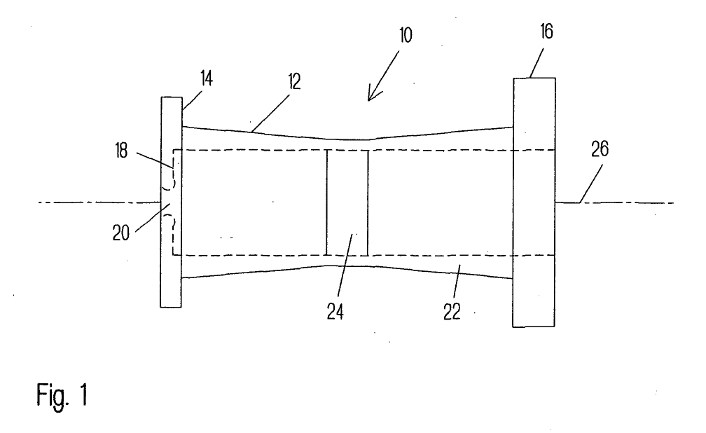

The sealing element 10 shown in FIG. 1 has a tubular main body 12, to the longitudinal ends of which are joined radially outwardly extending flanges 14 and 16. The sealing element 10 comprises a soft or medium-hard silicone rubber with a Shore hardness of 30 or more. Provided in the region of the flange 14 is an inwardly extending diaphragm 18 having a central circular opening 20.

The tubular main body has a peripheral wall 22 which encloses a central connecting passage 24 in the tubular main body 12. The diameter of the peripheral wall progressively increases from the region of the connecting passage 24 towards the flanges 14 and 16. The peripheral wall 22 is thus of the smallest wall thickness in the region of the connecting passage 24. The diameter of the connecting passage 24 is for example between 5 and 6 mm while the wall thickness of the peripheral wall 22 in the region of the connecting passage 24 is between 0.1 and 0.3 mm.

The diaphragm 18 is also of a wall thickness of between about 0.1 and 0.3 mm. The diameter of the opening 20 is between 1 and 2 mm.

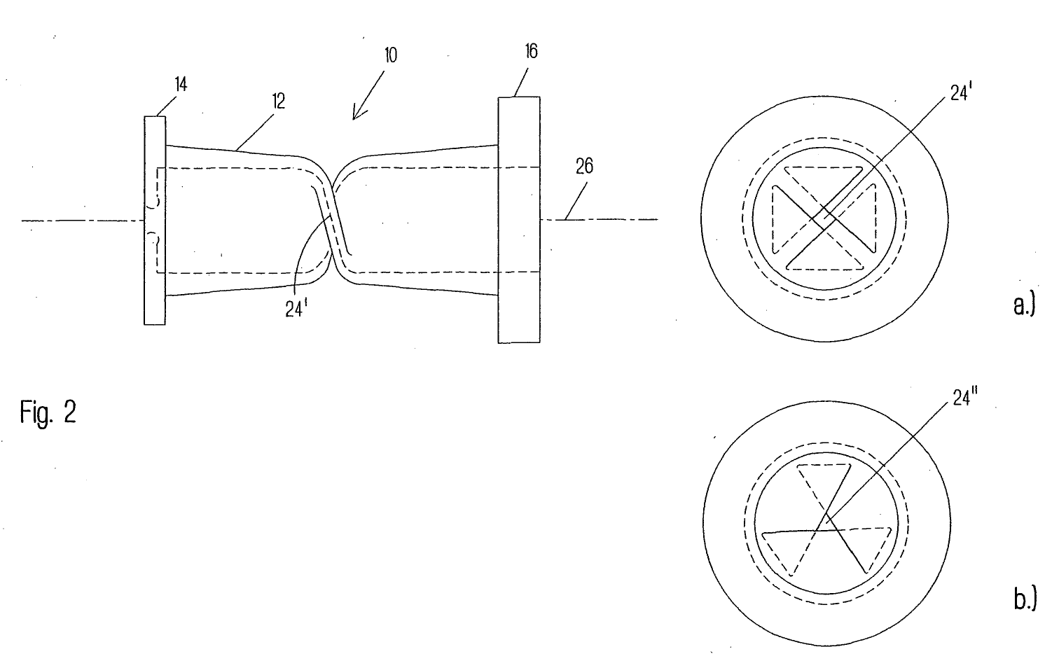

FIG. 2 shows the sealing element 10 of FIG. 1 in the twisted condition. This is the condition in which the two flanges 14 and 16 are rotated relative to each other about a longitudinal axis 26. It will be seen that a constriction is formed in the region of the connecting passage 24. When the peripheral wall 22 is of a suitable configuration that constriction is regular insofar as the peripheral wall 22 folds regularly in the region of the connecting passage 24, as shown in FIGS. 2a and 2b. In that way the connecting passage 24 (FIG. 2a) and 24′ (FIG. 2b) is formed in an iris-like shape and has an extremely high level of sealing effect. The constricted connecting passages 24′ and 24″ are obviously of a substantially smaller diameter than the fully open connecting passage 24 in FIG. 1.

The crucial consideration is that the diameter of the iris-shaped connecting passages 24′ and 24″ can be adjusted by the degree of angle by which the two flanges 14 and 16 are rotated relative to each other. A relatively slight rotation of the two flanges 14 and 16 relative to each other results in a smaller degree of narrowing of the connecting passage 24, that is to say it affords a larger diameter of the iris-shaped connecting passages 24′ and 24″ respectively. It is to be noted that the flanges 14 and 16 themselves are not an important consideration in regard to the essential property of the sealing element 10. Even without those flanges the sealing element 10 has the desired properties. The purpose of the flanges 14 and 16 is essentially to afford a way of connecting control elements for adjustment of the sealing element 10.

The diaphragm 18 with its central opening 20 serves as a second, auxiliary sealing element, in the case of insertion of an electrode line.

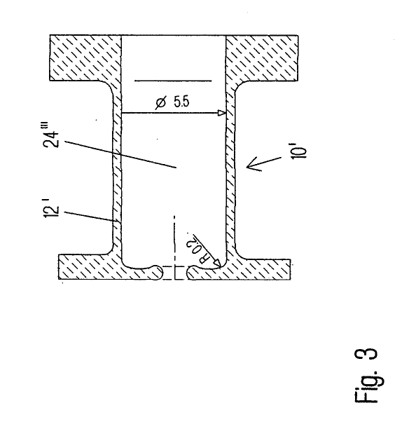

FIG. 3 shows an alternative embodiment of a sealing element 10′ as a sectional view. The dimensions in respect of the wall thickness of the peripheral wall 22′ and the connecting passage 24′″ approximately correspond to those of the embodiment shown in FIG. 1.

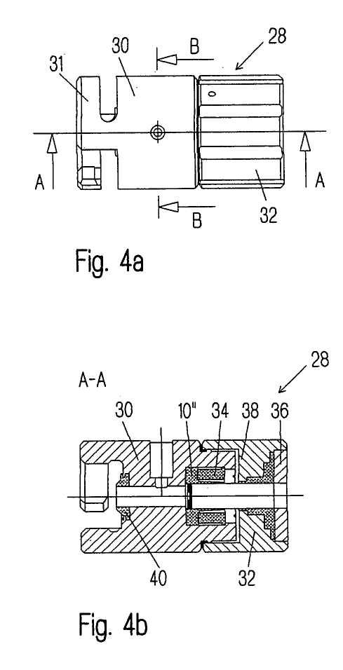

FIGS. 4a and 4b show a hemostatic valve 28 as is to be used as an essential connecting element for an insertion catheter which is not shown in FIGS. 4a and 4b. The hemostatic valve 28 includes a distal catheter connecting element 30 and a control element which are latchingly connected together and which are adapted to be rotatable relative to each other. The catheter connecting element 30 has a bayonet connection 31 with which the catheter connecting element 30 serving as the housing of the hemostatic valve is to be connected to a catheter. The control element 32 is in the form of a rotary ring. The distal connecting element 30 and the control element 32 form a first and a second control element, in the sense of the preamble to the description hereof.

The distal connecting element 30 and the control element 32 enclose a sealing element 10″ of the above-described kind. In this case, the distal connecting element 30 and the control element 32 are each connected to a respective flange of the sealing element 10″. A clamping sleeve 34 and a clamping pin 38 embody a latching mechanism which provides that the distal connecting element 30 and the control element 32 latch in various, mutually relatively rotated conditions. In that way a defined constriction of the sealing element 10″ can be implemented by rotation of the control element 32 with respect to the distal connecting element 30. That setting is retained even after the control element 32 is released. The two flanges of the sealing element 10″ are rotated relative to each other by relative rotation of the control element 32 with respect to the distal connecting element 30, with the consequence that the sealing element 10″ is constricted, as shown in FIG. 2. The distal flange of the control element 32 is for that purpose connected fixedly to the control element 32 by means of a clamping plate 36.

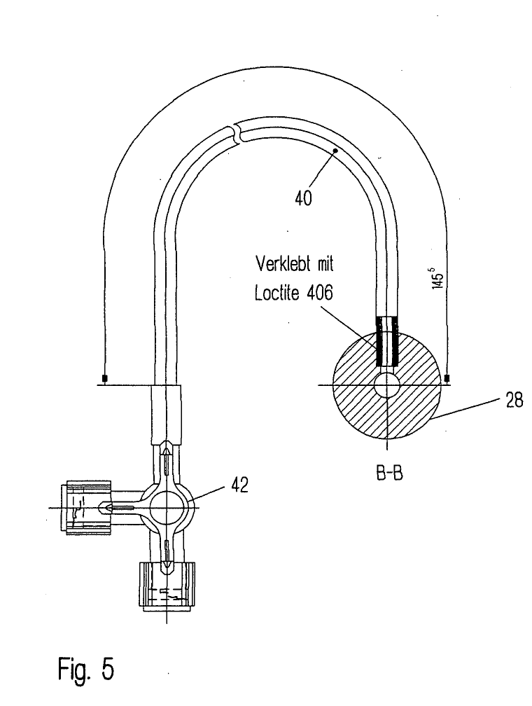

FIG. 5 also shows a hose 40 with a 3-way valve 42 connected thereto. The hemostatic valve 28 is also shown in a cross-section B-B.

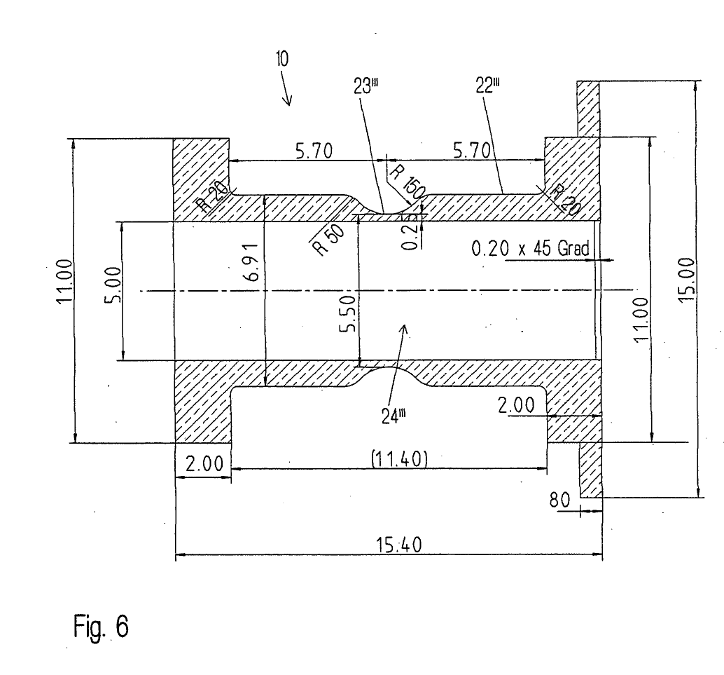

FIG. 6 shows a further alternative embodiment of a sealing element 10′″ similarly to FIG. 1 or FIG. 3. The sealing element 10′″ shown in FIG. 6 comprises silicone rubber of a Shore hardness of between 50 and 70.

The dimensions of the sealing element 10′″ can be seen from the longitudinal section in FIG. 6. The dimensions are specified in millimeters.

It will be seen that, in the case of the sealing element 10′″ shown in FIG. 6, the reduction in the wall thickness of the peripheral wall 22′″ is produced in the region of the connecting passage 24′″ by an annular grove 23′″ on the outside of the peripheral wall 22′″. The annular groove 23′″ provides that, upon being twisted, the sealing element 10′″ is constricted only in the region of the annular groove 23′″ and in the proximity thereof. In that way the location of the connecting passage 24′″ is also established in relation to the longitudinal direction of the sealing element 10′″.

What is claimed is:

1. A sealing element, comprising:
a tubular main body of an elastic material, a peripheral wall of the main body enclosing a hollow space that extends along a longitudinal direction of the sealing element, with a connecting passage for fluids,
wherein the peripheral wall in the region of the connecting passage is designed in respect of elasticity of the material, thickness of the wall and inside diameter of the hollow space, such that twisting of the main body causes a constriction of the hollow space in the region of the connecting passage in such a way that the constriction is at a predetermined position in relation to the longitudinal direction of the sealing element.

2. The sealing element of claim 1, wherein:
the tubular main body comprises first and second longitudinal ends, such that twisting of the two longitudinal ends relative to each other causes regular folding of the peripheral wall in the region of the connecting passage and concomitantly therewith a reduction in the diameter of the connecting passage, which is dependent on the amount of angular twist applied.

3. The sealing element of claim 2, wherein:
the peripheral wall has a smaller wall thickness in the region of the connecting passage than in adjacent wall regions.

4. The sealing element of claim 1, wherein:
the peripheral wall has a smaller wall thickness in the region of the connecting passage than in adjacent wall regions.

5. The sealing element of claim 3, wherein:
the wall thickness of the peripheral wall increases steadily with increasing distance from the connecting passage.

6. The sealing element of claim 4, wherein:
the wall thickness of the peripheral wall steadily increases with increasing distance from the connecting passage.

7. The sealing element of claim 3, wherein:
the wall thickness of the peripheral wall is substantially constant except in the region of the connecting passage, where the wall thickness is reduced.

8. The sealing element of claim 4, wherein:
the wall thickness of the peripheral wall is substantially constant except in the region of the connecting passage, where the wall thickness is reduced.

9. The sealing element of claim 2, further comprising:
a flange at the first longitudinal end of the sealing element, the flange extending radially outwardly from the tubular main body.

10. The sealing element of claim 9, further comprising:
a flange at each longitudinal end of the sealing element.

11. The sealing element of claim 2, further comprising:
a diaphragm which at least partially closes at least one longitudinal end of the sealing element.

12. The sealing element of claim 11, wherein:
the diaphragm has a central opening, a diameter of which is smaller than the diameter of the connecting passage in the fully open condition.

13. The sealing element of claim 1, wherein:
the tubular main body comprises a silicone rubber.

14. The sealing element of claim 13, wherein:
the tubular main body comprises a material with a Shore hardness greater than 30.

15. The sealing element of claim 1, wherein:
the tubular main body comprises a material with a Shore hardness greater than 30.

16. The sealing element of claim 14, wherein:
the Shore hardness is 50 or greater.

17. The sealing element of claim 25, wherein:
the Shore hardness is 50 or greater.

18. The sealing element of claim 16, wherein:
the Shore hardness is between 50 and 70.

19. The sealing element of claim 17, wherein:
the Shore hardness is between 50 and 70.

20. The sealing element of claim 1, wherein:
when the connecting passage is fully open the hollow space is of a round diameter which is substantially uniform over the longitudinal direction so that the hollow space is in the form of a cylinder open at the two ends thereof.

21. An insertion catheter, comprising:
a sealing element, wherein the sealing element comprises a tubular main body of an elastic material, a peripheral wall of the main body enclosing a hollow space that extends along a longitudinal direction of the sealing element, with a connecting passage for fluids,
wherein the peripheral wall in the region of the connecting passage is designed in respect of elasticity of the material, thickness of the wall and inside diameter of the hollow space, such that twisting of the main body causes a constriction of the hollow space in the region of the connecting passage in such a way that the constriction is at a predetermined position in relation to the longitudinal direction of the sealing element.

22. The insertion catheter of claim 21, further comprising:
an insertion opening for electrode lines, guide wires or the like which are to be inserted into a vessel by means of the insertion catheter,
wherein the sealing element is arranged in a region of the insertion opening.

23. The insertion catheter of claim 22, wherein:
the sealing element is arranged and designed for selectively closing or opening the insertion opening.

24. The insertion catheter of claim 23, wherein:
the insertion catheter has two mutually relatively rotatable control elements which are each operatively connected to a respective longitudinal end of the sealing element for setting the diameter of the connecting passage of the sealing element.

25. The insertion catheter of claim 24, wherein:
the control elements are arranged in the region of the insertion opening of the insertion catheter.

26. The insertion catheter of claim 25, wherein:
the control elements retain various, mutually relatively rotated positions after setting thereof.

27. The insertion catheter of claim 24, wherein:
the control elements retain various, mutually relatively rotated positions after setting thereof.

28. The insertion catheter of claim 26, wherein:
the control elements latch in various, mutually relatively rotated positions.
